(19) United States
(12) Patent Application Publication
(10) Pub. No.: US 2023/0050120 A1
(43) Pub. Date: Feb. 16, 2023

(54) METHOD FOR LEARNING REPRESENTATIONS FROM CLOUDS OF POINTS DATA AND A CORRESPONDING SYSTEM

(71) Applicant: NEC Laboratories Europe GmbH, Heidelberg (DE)

(72) Inventor: Daniel ONORO-RUBIO, Heidelberg (DE)

(21) Appl. No.: 17/793,431

(22) PCT Filed: Jun. 8, 2020
(86) PCT No.: PCT/EP2020/065881

§ 371 Date: Jul. 18, 2022

(51) Int. Cl. G06N 3/08; G06K 9/62; G06V 10/75; G06V 10/82

(52) U.S. Cl. CPC G06N 3/08; G06K 9/6256; G06V 10/757; G06V 10/82

(57) ABSTRACT

A method for learning representations from clouds of points data includes encoding clouds of points data into at least one representation by creating at least one tensor representation out of the clouds of points data. The method further includes using a loss function that utilizes a noisy reconstruction for reducing overfitting.

### CROSS REFERENCE TO RELATED APPLICATIONS

This application is a U.S. National Phase application under 35 U.S.C. § 371 of International Application No. PCT/EP2020/065881, filed on Jun. 8, 2020. The International Application was published in English on Dec. 16, 2021, as WO 2021/249619 A1 under PCT Article 21(2).

### FIELD

The present disclosure relates to a method for learning representations from clouds of points data. The present disclosure further relates to a system for learning representations from clouds of points data.

### BACKGROUND

Biometric matching and particularly fingerprint or face matching are important fields of technology. The known technology achieves high accuracy on this task. However, one of the greatest inconveniences of known technology is that it is computationally expensive.

These important fields of technology and known technologies deal with the aim of an efficient matching of clouds of points. Given a sample that consists of a collection of data points and its associated features, it is desired to retrieve, from a large pool of samples or clouds of points, the most similar sample or cloud of points.

Corresponding prior art documents are listed as follows:
[1] Davide Maltoni; Dario Maio; Anil K. Jain; Salil Prabhakar (Apr. 21, 2009). Handbook of Fingerprint Recognition. Springer Science & Business Media. p. 216. ISBN 978-1-84882-254-2.
[2] Joshua J. Engelsma, Kai Cao, Anil K. Jain. Learning a Fixed-Length Fingerprint Representation. Joshua J. Engelsma, Kai Cao, Anil K. Jain. 2019.
[3] Aaron van den Oord, Yazhe Li, Oriol Vinyals. Representation Learning with Contrastive Predictive Coding. arXiv:1807.03748, 2018.
[4] Method and device for matching fingerprints with precise minutia pairs selected from coarse pairs. U.S. Pat. No. 4,646,352.
[5] Face recognition using face tracker classifier data. U.S. Pat. No. 8,687,078.
[6] Foldingnet: Point Cloud Auto-Encoder Via Deep Grid Deformation. Yaoqing Yang, Chen Feng, Yiru Shen, Dong Tian. CVPR 2018.
[7] Unsupervised Discovery Of Object Landmarks As Structural Representations. Yuting Zhang, Yijie Guo, Yixin Jin, Yijun Luo, Zhiyuan He, Honglak Lee. CVPR 2018.

Efficiently matching samples of clouds of points with arbitrary sizes is a difficult problem. It usually involves brute force comparison between points, which makes the computation expensive. Some efforts are trying to learn representations from arbitrary points of clouds such as in [6]. In this document, it is proposed an auto-encoder to learn an unsupervised representation of 3D objects. However, this model is not designed to learn representations for matching or ranking problems. Moreover, the model is computationally expensive. Other approaches, such as in [7], propose a model based on 3 U-Net like neural networks to learn to predict in an unsupervised fashion landmark points. However, for each image, it is expected to have a fixed number of landmarks to be discovered. The model is not designed to perform matching or ranking queries. Moreover, the complexity of the model presumably makes the run time too slow.

### SUMMARY

In an embodiment, the present disclosure provides a method for learning representations from clouds of points data. The method includes encoding clouds of points data into at least one representation by creating at least one tensor representation out of the clouds of points data. The method further includes using a loss function that utilizes a noisy reconstruction for reducing overfitting.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows in a diagram a baseline model wherein inputs—for example images-pass through an ANN and are converted into embedding;

FIG. 2 shows a diagram sketching how data points are converted into a tensor, wherein each point is converted into 2D coordinates that lie between a predefined height h and width w, wherein the associated features are put as values in their channels, wherein data augmentation techniques, such as rotation, distortion in the locations, feature value pollution, etc., can be applied, and wherein finally, smoothing is performed by applying a Gaussian kernel or another technique;

FIG. 3 shows a diagram, wherein the input point clouds are projected and augmented, then are passed to the encoder network where the embeddings are generated, wherein at the same time, a decoder network with dropout sampling is added to reconstruct noisy versions of the input, wherein the reconstructed inputs are passed again to the encoder to get their embeddings and wherein the model is trained to minimize the loss;

FIG. 4 shows, in a diagram, a mean ranking per batch plots, wherein the first row corresponds to the baseline experiment, and the second row is the results, and wherein the first column shows the mean rank over the training set, while the second column shows the results over the validation set;

FIG. 5 shows, in a diagram, an application for fingerprint matching or face matching; and

FIG. 6 shows, in a diagram, an application embodiment for pose estimation, landmark matching, or monument retrieval.

### DETAILED DESCRIPTION

The present disclosure provides for improving and further developing a method for learning representations from clouds of points data and a corresponding system for learning representations from clouds of points data for providing an efficient method for learning representations, particularly for a fast biometric matching search.

The disclosure provides a method for learning representations from clouds of points data, comprising: encoding clouds of points data into at least one representation by creating at least one tensor representation out of the clouds of points data and using a loss function that uses a noisy reconstruction for reducing overfitting.

The disclosure further provides a system for learning representations from clouds of points data, comprising: encoding means for encoding clouds of points data into at least one representation by creating at least one tensor representation out of the clouds of points data and using means or computing means for using a loss function that uses a noisy reconstruction for reducing overfitting.

It is possible to provide a very efficient method for learning representations from clouds of points data by a smart encoding process. Encoding clouds of points data into at least one representation by creating at least one tensor representation out of the clouds of points data provides such a smart encoding. Further, a special loss function that uses a noisy reconstruction for reducing overfitting can be used. A method comprising this special encoding and special use of a loss function is particularly suitable for providing an efficient method for learning representations, particularly for a fast biometric matching search.

Thus, an efficient method and system for learning representations, particularly for a fast biometric matching search, are provided by the present disclosure.

According to an embodiment of the invention, the clouds of points data or the points of the clouds of points data are projected into tensors. Such tensors can have a predefined height, width and channel depth. The use of tensors provides a smart basis for performing a method for learning representations from clouds of points data.

Within a further embodiment, the clouds of points data or these points are converted into 2D locations that lie in a defined height and width. Thus, a simple structuring of clouds of points data or points is possible.

According to a further embodiment, associated features of several or of each of these points are encoded into a c dimension. This c dimension can be directed along the length of a channel. Thus, a simple structuring of associated features is possible.

A further embodiment provides a method, wherein the encoding is performed together with at least one data augmentation technique, wherein the at least one data augmentation technique can comprise at least one rotation, translation and/or other type of distortion.

Within a further embodiment, the loss function is an unsupervised loss function.

According to a further embodiment, the loss function cooperates with a machine learning model. The machine learning model can use usual machine learning techniques.

Within a further embodiment, the loss function cooperates with a Neural Network, NN, or Artificial Neural Network, ANN.

A further embodiment provides a method, wherein the clouds of points data, i.e. inputs, are passed through the NN or ANN. This can be performed for encoding them into a latent representation.

According to a further embodiment, the noisy reconstruction or noisy reconstructions is or are produced by a decoder or encoder with dropout sampling.

Within a further embodiment, the decoder or encoder produces noisy versions of the clouds of points data, i.e. the inputs. These noisy versions can be passed back to the decoder or encoder for generating embeddings of the inputs.

According to a further embodiment, the clouds of points comprise 2D clouds of points.

A further embodiment provides a method, wherein the method is used for matching of clouds of points. This matching of clouds of points can be biometric matching, fingerprint matching or face matching, wherein a cloud of points represents a biometric sample, a fingerprint or a face.

Within a further embodiment, the matching is obtained by finding the most similar cloud of points or clouds of points of the clouds of points data. A ranking of at least several clouds of points regarding similarity can be performed.

Advantages and aspects of embodiments of the present invention are summarized as follows:

Embodiments propose an efficient framework for projecting clouds of points into one or more tensor spaces, and an unsupervised loss or loss function that makes use of noisy reconstructions to learning a robust data representation that is used to efficiently rank millions of samples per second, and left a small pool of samples in which to find the exact match.

Further embodiments propose a general method for learning representations from data that come from 2D clouds of points, for example. The disclosure provides a novel way to encode clouds of points into images. The proposed encoding allows performing multiple data augmentation techniques, which can be used as a way to augment a training set and reduce overfitting. Additionally, a new unsupervised loss or loss function is added to the training, which efficiently allows reducing the overfitting problem, and efficiently increasing the overall performance of the representation learned. The learned representation can be used for the sample matching problem on its own or used to rank a dataset with a slow but precise algorithm. An application example is for the biometric matching, the fingerprint matching or the face recognition matching.

Further advantages and aspects of the disclosure are summarized as follows:

1) Embodiments of this invention provide a novel encoding method that creates tensor representations out of clouds of points.
2) Further embodiments comprise the use of a decoder with dropout sampling that produces noisy reconstructions and its use with a novel unsupervised loss function that uses a noisy reconstruction to efficiently reduce the overfitting and increases the robustness of the learned representations.
3) Further embodiments deal with one or more datasets which contain samples from which clouds of points can be extracted for matching purposes. For example, fingerprint, faces, etc.
4) According to embodiments of the invention, the proposed encoding method creates tensor representations from the points of clouds data, wherein the encoding method can be used in combination with data augmentation techniques that are performed at this level.
5) According to further embodiments of the invention, it is proposed an unsupervised loss function that makes use of a decoder which can have dropout that produces noisy reconstructions to learn robust encoding representations.

In contrast to the prior art, embodiments of the present invention provide an efficient method for learning representations for fast biometric matching search which can be used without the raw images, i.e. just with the point clouds.

Embodiments of the present invention can be applied for fast biometric matching. The current invention can improve the speed and performance in fingerprint and face matching, for example.

### Example Embodiment in Biometric

The disclosure provides a general method for learning compressed latent representations of data samples, in which at least one of its components can be expressed as a 2D point cloud. The present invention proposes a novel mechanism to encode the data and an efficient unsupervised loss that allows any arbitrary machine learning model to efficiently learn robust data representations for the sample matching problem, which in other ways could not be achieved. The effectiveness of the current invention was probed in natural data—fingerprints—and synthetically generated data, having similar results in both scenarios.

In order to define the problem, we are going to clarify the notation. In a low case bold letters such as x, represent vectors. In an upper case letters define tensors or sets of vectors. Therefore, having a dataset D in the form of D={s₁, s₂, . . . , sₙ|t₁, t₂, . . . , tₙ|b₁, b₂, . . . , bₙ}, where x={s, t, b} ε R^{d} and d is an integer with d=3, for example, there is a matching correspondence between sᵢ, source, and tᵢ, target, and bᵢ, background, are samples without any matching correspondence, i=1, . . . , n and n is an integer. We want to learn a presentation E such as f(x|W)=e and satisfied that the distance d(e^{s}, e^{t})<d(e^{s}, e^{b}). Therefore, a typical approach would follow the following steps:

1. Create batches of samples X={S, T, B}.
2. Apply standard data augmentation techniques, such rotations, translations, and other type of distortions, if it is possible. This is typically possible with images, but hard with other types of data such as numerical features.
3. Learn a Neural Network, by minimizing a contrastive loss such as the infoNCE [3].
(1)

$$info NCE ( {e}^{s} , {e}^{t} , {E}^{b} ) = - log \frac{exp ( sim ( {e}^{s} , {e}^{t} ) / τ )}{{\sum }_{i = 0}^{n} exp ( \frac{s i m ( {e}^{s} , {e}_{i}^{b} )}{τ} )}$$

where sim(⋅,⋅), can be any similarity function such as the cosine similarity.
4. At test time the matchings are obtained by finding the most similar sample between e^{s} in a pool of E^{t} ∪ E^{b}.

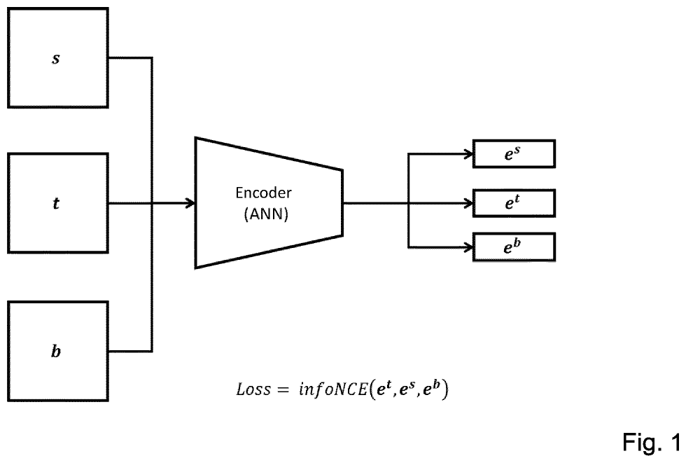

FIG. 1 shows the typical diagram of a baseline model. On the left side, the inputs —typically images—are depicted. They pass through an ANN that encodes them into a latent representation. The latent representations are connected to a contrastive loss such as infoNCE loss. The encoder is optimized to minimize the mentioned loss. We are going to refer to this experiment as the baseline experiment.

Conventional methods have limitations in applying data augmentation to the input. Typically, the data augmentation can be applied if the input is images. Another limitation, the dimensionality of the input has to be normalized to some template size. These situations make it very difficult to learn robust representation particularly for those cases in which the raw images are not present. In these cases, the lack of data augmentation might lead to over-fitting problems and poor performance of the learned model. In embodiments of the present invention we propose: first, a new method to encode the input into point clouds in which data augmentation is performed, even if the raw input is not present; second, a new unsupervised loss to enhance the learning capability of the models during the training and efficiently prevent the over-fitting. This is reflected in the training curves and the final results. Therefore, embodiments of the invention can be summarized as follows:

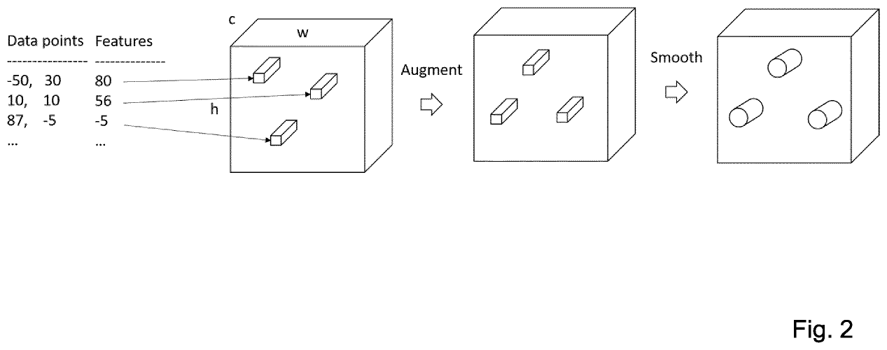

1. Create batches of samples X={S, T, B}.
2. Apply our novel encoding system to project points into tensors with a predefined height, width and channel depth (h×w×c). FIG. 2 shows a diagram how embodiments of the proposed invention can be performed.
a) Convert the points into 2D locations that lie in a defined height h, and width w. The height h and width w of the space are hyper-parameters of the model.
b) Encode associated features of each point into a c dimensional. The values are copied over channels of each point in its 2D position.
c) Apply points drop out, point injection, additive noise, rotations, translation, and/or pressure or spreading of the points.
d) Smooth the resulting image by applying a Gaussian kernel.
3. Apply standard data augmentation techniques, such rotations, translations, and other type of distortions, if it is possible. This is typically possible with images, but hard with other types of data such as numerical features.
4. Train a ANN to minimize the proposed novel loss or loss function:

Los(s,t,b)=infoNCE(e^{s},e^{t},e^{b})+rec(\hat{x})+rec(t)+rec(b)+infoNCE(e^{s},e^{ŝ},e^{b})+infoNCE(e^{t},e^{\hat{t}},e^{b}) (2)

where rec(⋅) is the reconstruction loss, and \hat{x} is a noisy reconstruction of the input where a dropout sampling on the decoder is used.

5. At test time the matching is obtained by finding the most similar sample between e^{s} in a pool of E^{t}.
6. Additionally, at test time, the proposed tensor transformation of (2) and illustrated in FIG. 2, allows the invention to extract embedding by regions. Therefore, having a tensor with the shape [h, w, c], the [h, w] area can be divided into regions with overlapping or not, and embedding can be extracted from each region. Then, a source embedding e^{s} can be now compared with a set of target embedding E^{t}={e₁^{t}, e₂^{t}, . . . , eᵣ^{t},} which corresponds to the information extracted from each region of a larger point cloud mapping, where r is the number of regions.

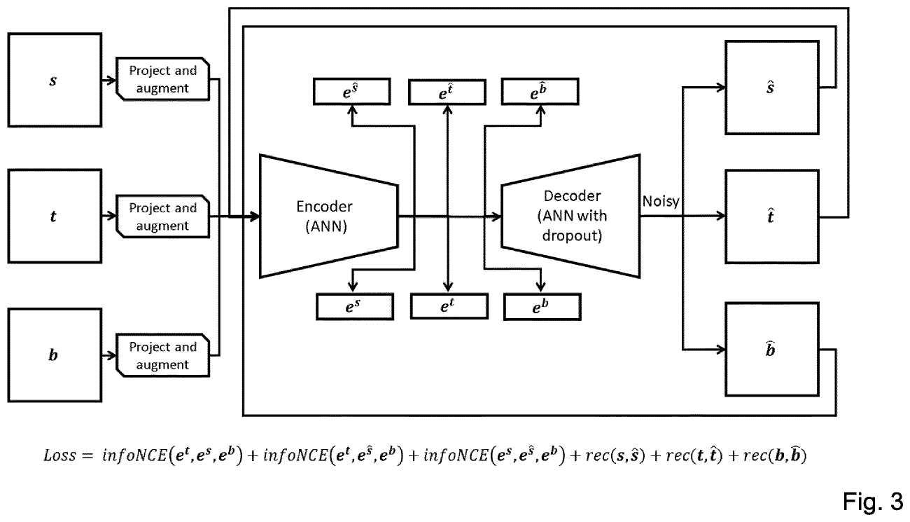

FIG. 3 shows a diagram of an embodiment of the proposed invention. The first novelty is in how the input is projected. The clouds of points are converted into images or representations, and the features associated are encoded as colors. In this process, we can perform a new level of data augmentation, by dropping out points, adding new points, spreading or enclosing them, rotation, etc. Afterward, the image is smoothed, and the typical image data augmentation techniques can be applied. Similarly to the baseline example, an encoder converts the inputs into latent embeddings. As for the second novelty of this embodiment, an encoder with dropout sampling is added. This encoder will produce noisy versions of the input. This noisy versions are passed back to the encoder and the embedding is generated. The idea is that the embedding of the original inputs should be similar to the noisily reconstructed inputs, and different to anything else. Therefore, the loss is the contrastive loss between the original matches, plus the contrastive loss between the original data and the noisily reconstructed data, plus the reconstruction loss of all the samples.

### Experiments:

The proposed idea is empirically tested in real fingerprint minutia data and synthetically generated data with similar results. Due to data privacy issues, here are just shown the results obtained on the synthetically generated dataset. The dataset contains a total of 202500 pairs of samples and it is split in train, validation and test set, resulting in:

| Train | Validation | Test |
|---|---|---|
| 100000 | 2500 | 100000 |

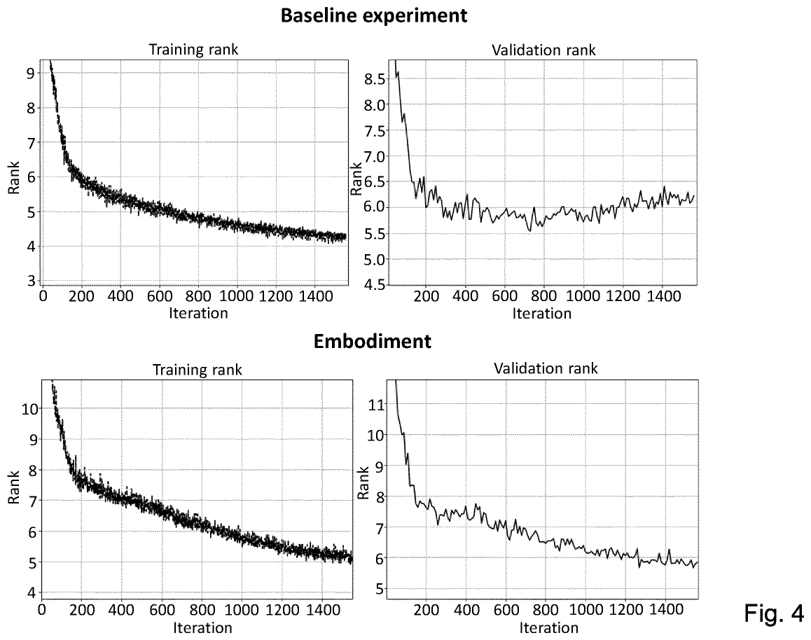

For the experiment, we trained the baseline framework and an embodiment of the proposed invention. The models are identically initialized and trained for the same amount of time. In FIG. 4 is plotted the evolution of the mean rank for the matching problem. The first column shows the evolution over the training set while the second column plots the evolution over the validation set. The first row shows the results for the baseline experiment while the second row shows the results of the embodiment of the proposed invention. The mean rank of the baseline experiment in the training set progressively decreases over time, however, the validation set starts to increase after the first half of the training. This behavior indicates that the model is overfitting. In contrast, the ranks of the embodiment of the proposed invention are progressively decreasing during the entire training, and the overfitting effect is efficiently addressed. This is also reflected in the final results. Since the overfitting is a clear issue of baseline, we will take the best performing checkpoint over the validation set for both models. Then we compute the mean rank, hit@1, hit@10, and hit@100. The results are summarized in the following table:

| Experiment | Mean | Hit@1 | Hit@10 | Hit@100 |
|---|---|---|---|---|
| Baseline | 476 | 0.039 | 0.117 | 0.398 |
| Embodiment | 466 | 0.070 | 0.172 | 0.444 |

Besides, embodiments of the proposed invention can run fast. In a conventional GPU, we could achieve an order of 350 million matches per second.

### Example Embodiment in Biometric

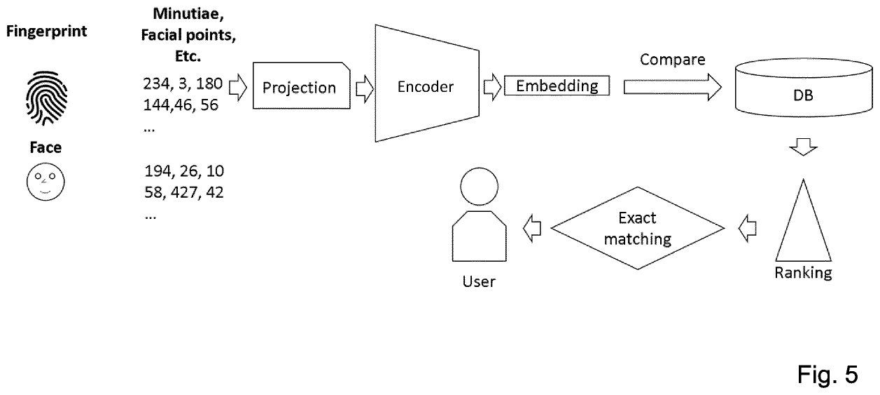

Fingerprints are the impressions left by the fingers after applying some pressure on a surface. These impressions are unique identifiers of a particular person, and they have been efficiently used by law enforcement, forensic science, identification systems, and other applications. The difficulty of the problem came with the sample matching. Typically, for a given fingerprint sample q, we want to find the exact match in the pool of T samples. This makes this task as difficult as looking for a needle in a haystack which is unfeasible for human beings. Here is where the computer sciences play a crucial role in the task of comparing the query sample q against millions of samples. There are typically many approaches to extracting features such as looking for arch, loop, whorl or minutiae [1, 4]. The minutiae are the 2D locations ([x,y]) in which two lines are joining, a line finishes or starts. Among all the mentioned features, the minutiae are the most commonly used. Therefore, a typical fingerprint matching algorithm is going to compute a score based on how well the minutiae between the query fingerprint q and a target t match. This scoring function typically involves computationally expensive operations which typically involve computing distances between the minutiae in order to find the correspondence, and usually involve tying many rotation and translations to one of the pairs in order to find the best transformation for the exact matching. A similar approach is applied to the face recognition problem [5]. The proposed invention can be used as a mechanism to rank the dataset to drastically reduce the number of computationally expensive comparisons. FIG. 5 shows a diagram example. The minutiae of the facial points are projected into an image matrix. The image is passed through to the learned encoder to obtain the embedding. The embedding is compared with some similarity or distance metric with a database that contains all the precomputed embedding. The scores are shorted in order to create a rank of candidates. An exact matching algorithm over the input data, or any other slow algorithm, can be now applied following the ranking order generated by an embodiment of our proposed algorithm. This will drastically increase the chances of finding the correct match.

### Example Embodiment in Landmark/Anchor Based Retrieval

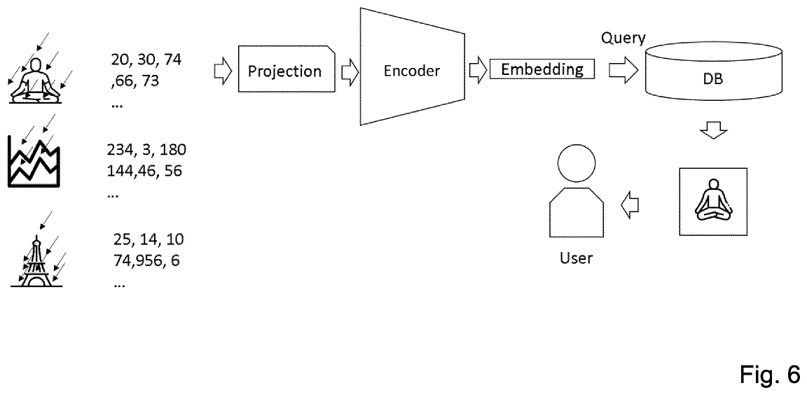

Having a collection of data where each data sample is an image or any other type of data, in which a collection of landmark points can be extracted to represent that example. We define the problem of the landmark-based retrieval as having a query sample q, and a large database of samples T, we want to retrieve the most similar sample t to q. Examples of this type of problem are the geographical topology matching, monument retrieval, pose estimation, etc. FIG. 6 shows a diagram example of a possible system. On the left is represented the raw data. From this data, a collection of landmarks or anchor points are extracted. Afterward, they are projected following and encoded following the procedure described in this description. Then, a query based on the embedding similarity can be done, and the same or similar examples to the query could be retrieved.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for learning representations from clouds of points data, comprising:
encoding clouds of points data into at least one representation by creating at least one tensor representation out of the clouds of points data; and
using a loss function that utilizes a noisy reconstruction for reducing overfitting.

2. The method according to claim 1, wherein the clouds of points data or points of the clouds of points data are projected into tensors having a predefined height, width, and channel depth.

3. The method according to claim 1, wherein the clouds of points data or points of the clouds of points data are converted into 2D locations that lie in a defined height and width.

4. The method according to claim 3, wherein associated features of several points of the clouds of points data or each point of the clouds of points data are encoded into a c dimension directed along a length of a channel.

5. The method according to claim 1, wherein the encoding is performed together with at least one data augmentation technique, wherein the at least one data augmentation technique includes at least one rotation, translation, and/or other type of distortion.

6. The method according to claim 1, wherein the loss function is an unsupervised loss function.

7. The method according to claim 1, wherein the loss function cooperates with a machine learning model.

8. The method according to claim 1, wherein the loss function cooperates with a Neural Network (NN) or Artificial Neural Network (ANN).

9. The method according to claim 8, wherein the clouds of points data are passed through the NN or ANN.

10. The method according to claim 1, wherein the noisy reconstruction is produced by a decoder or encoder with dropout sampling.

11. The method according to claim 10, wherein the decoder or encoder produces noisy versions of the clouds of points data, wherein the noisy versions are passed back to the decoder or encoder for generating embeddings of the inputs.

12. The method according to claim 1, wherein the clouds of points data comprise 2D clouds of points.

13. The method according to claim 1, wherein the method is used for matching of clouds of points for biometric matching, fingerprint matching or face matching, wherein a cloud of points represents a biometric sample, a fingerprint or a face.

14. The method according to claim 13, wherein the matching is obtained by finding a most similar cloud of points or clouds of points of the clouds of points data.

15. A system for learning representations from clouds of points data, the system comprising:
an encoder configured to encode clouds of points data into at least one representation by creating at least one tensor representation out of the clouds of points data; and
processing circuitry configured to use a loss function that utilizes a noisy reconstruction for reducing overfitting.
